(19) United States
(12) Patent Application Publication
(10) Pub. No.: US 2015/0172776 A1
(43) Pub. Date: Jun. 18, 2015

(54) MULTI-MODE RING CLOCK

(71) Applicant: Stephane Haziza, Woodland Hills, CA (US)

(72) Inventor: Stephane Haziza, Woodland Hills, CA (US)

(73) Assignee: THOMSON LICENSING, Issy Les Moulineaux (FR)

(21) Appl. No.: 14/372,228

(22) PCT Filed: Jan. 18, 2012
(86) PCT No.: PCT/US2012/021629

§ 371 Date: Jul. 15, 2014

(51) Int. Cl. H04N 21/482; H04N 21/485

(52) U.S. Cl. CPC H04N 21/4821; H04N 21/485

(57) ABSTRACT

A multi-mode ring clock can be embodied as a ring of illuminable segments, each of which can be individually controlled to display time and timer information associated with using a digital video recorder (DVR) in a set top box. Time and timer information can include displays for time of day, for starting and stopping recordings, for measuring elapsed time and remaining time, and for setting a playback time for a recording. The multi-mode ring clock is responsive to control signals from clock circuitry inside the set top box that is already provided for purposes other than controlling the multi-mode ring clock. Special time and timer indications can be related to different aspects of managing DVR recordings.

### DESCRIPTION OF RELATED ART

Set top boxes manufactured by Technicolor, formerly Thomson, have included and continue to include a decorative, illuminated ring on the front panel. A clock formed by multiple rings of LED's is shown and described at the website www.docstoc.com/docs/22698404/Circular-LED-Clock. An “Abyss” digital watch implemented as a ring of LED's is available from the Chinavision Company, and is shown and described at the website www.ubergizmo.com/2010/07/abyss-led-digital-watch/. U.S. Pat. No. 3,772,874—Lefkowitz discloses numerous arrangements of clocks formed by liquid crystal display (LCD) segments. U.S. Pat. No. 3,958,409 discloses a watch display formed by first and second concentric circular arrays of light emitting diodes which are sequentially energized to indicate the minutes and hours such that only one diode from each array is energized at any one time. U.S. Pat. No. 4,041,692—Marshino discloses an electronic clock having a time indicating light display on the clock face with the light display being provided by a plurality of light emitting diodes positioned to form three spaced concentric rings for separately indicating time in seconds, minutes and hours. U.S. Pat. No. 3,456,152—Anderson discloses the use of cold cathode electric discharge tubes arranged in concentric circular arrays to represent the hours, minutes and seconds by glowing spots or numerals. U.S. Pat. No. 3,540,209—Zatsky discloses a liquid electro-optical material between a crystal and a dial plate. The crystal or the dial plate, or both, have a plurality of conductive transparent lines that are electrically triggered in sequence to provide a moving indication of the time which appears similar to moving hands.

### SUMMARY OF THE INVENTION

A useful and attractive enhancement for the front panels of set top boxes, particularly but not necessarily limited to those set top boxes already having illuminated light rings, is to embody the illuminated light ring as a clock that can provide indications of a standard time keeping function as well as one or more special timer or time measuring functions associated with managing use of a digital video recorder (DVR) as can be found in many television set top boxes. Such a clock is also referred to herein as a multi-mode ring clock, a multi-mode light ring clock and a multi-mode ring-shaped clock. The light ring clock can be advantageously embodied as a ring of separately addressable LED's, each of which can be turned on, turned off and blinked at different rates and duty cycles. Other lights suitable for a segmented display include, for example, organic light emitting diodes, liquid crystals and quantum dots. The light ring clock can also be advantageously embodied to operate responsive to time signals that are already generated inside the existing circuitry of the set top box, for example, those that control the DVR functions. The light ring clock can be further advantageously embodied to selectably and controllably provide and indicate a time keeping function, for example a time of day function, as well as one or more special time measuring functions generally related to managing DVR recordings, for example timer functions. Such special time-measuring functions can advantageously include, without limitation, one or more recording management functions, such as capturing content, starting a recording, measuring elapsed time of a recording, measuring time remaining for a recording and setting a display time for viewing recorded content.

### BRIEF DESCRIPTION OF THE DRAWINGS

FIG. 1 is a diagram of the front panel of a set top box embodying the inventive arrangements.

FIG. 2(a) is an enlarged depiction of the ring clock shown in FIG. 1, indicating a time-of-day and a first way of implementing a time-of-day function.

FIG. 2(b) is an enlarged depiction of the ring clock shown in FIG. 1, illustrating a different time-of-and a second way of implementing a time-of-day function.

FIG. 3 illustrates exemplary first and second menus that can be generated by the set top box as part of the user interface and that can be used by a viewer to manage DVR recording functions.

FIG. 4 is a diagram of the front panel of a set top box embodying the inventive arrangements, and depicting an operating mode different than shown in FIGS. 2(a) and 2(b).

FIG. 5 illustrates an exemplary user interface screen that can be generated by the set top box for the Elapsed Time aspect of managing recordings.

FIG. 6 is an enlarged depiction of the ring clock shown in FIG. 4, illustrating a chronograph or timer mode for the Elapsed Time aspect of managing recordings.

FIGS. 7-8 illustrate an exemplary user interface screen that can be generated by the set top box for the Count Down aspect of managing recordings.

FIG. 9 further illustrates operation of the ring clock in the chronograph mode.

FIG. 10 illustrates a first alternative ring clock having multiple rings of illuminable segments.

FIG. 11 illustrates a second alternative ring clock having multiple rings of illuminable segments.

FIG. 12 is a block diagram illustrating how clock control signals in a set top box can be routed for controlling the ring clock.

### DETAILED DESCRIPTION OF THE PREFERRED EMBODIMENTS

The invention relates to a set top box with improved user interface features. Set top boxes are often provided with a digital video recorder (DVR). Digital video recorders are also often referred to as personal video recorders (PVR). For purposes of this description, the terms DVR and PVR are deemed to be interchangeable. A set top box with a DVR is further provided with first circuitry for processing and generating time control signals for said DVR and second circuitry for generating a user interface enabling implementation of DVR recording modes. The DVR recording modes generally require, and operate in accordance with different ones of said time control signals.

Set top boxes are provided with a front panel that often serves as a control panel, in addition to the remote control unit provided with such set top boxes. Thus, the front panel of a set top box, particularly a set top box provided with a DVR, usually includes a plurality of user activatable controls and status indicators, often illuminated, that perform some but not all of the functions that are available when using the remote control unit.

Some set top boxes with DVR's, including many of those manufactured by Technicolor, formerly Thomson, have been provided with a decorative illuminated ring surrounding the control switch on the set top box associated with navigation through the program guide menu system of the user interface generated by the set top box.

In accordance with the inventive arrangements, the decorative illuminated ring is replaced by a multi-mode ring-shaped clock formed by a plurality of independently illuminable segments operable in response to the time control signals generated for the DVR and in accordance with the DVR recording modes. In further accordance with the presently preferred embodiments, each of the illuminable segments can be independently turned on, turned off and blinked at different rates and duty cycles. The multi-mode ring-shaped clock can also be advantageously provided in set top boxes never having been provided with a decorative illuminated ring, or the like.

In the presently preferred embodiment, the illuminable segments of the clock can comprise individually addressable light emitting diodes. Other sources of illumination suitable for a segmented display include, for example, organic light emitting diodes, liquid crystals and quantum dots. The clock segments can be illuminated to depict times for starting and stopping recordings, measuring elapsed times and remaining times for recordings, and times for playing back recordings. The illuminable clock segments can be individually controlled to be on, to be off, to blink at different rates and with different duty cycles and to be turned on or off in sequence to visually depict the elapsed and remaining times.

Despite the segmented nature of the illuminable segments, the illuminable segments provide a visually perceivable analog information display. The information display depicts or represents an analog clock or an analog timer in accordance with different ones of said DVR recording modes.

The time control signals can comprise first control signals enabling indication of time of day by said clock and second control signals enabling indication of elapsed time and time remaining by said clock.

The inventive arrangements can also be thought of as an improved set top box, comprising: a digital video recorder (DVR); first circuitry for processing and generating time control signals for said DVR; second circuitry for generating a user interface enabling implementation of DVR recording modes, said DVR recording modes requiring different ones of said time control signals; and, a front panel; wherein the improvement comprises a multi-mode ring-shaped clock on the front panel, formed by a plurality of independently illuminable segments operable in response to the time control signals generated for the DVR, and in accordance with the DVR recording modes.

In the improved set top box, the illuminable segments provide the same kind of visually perceivable analog information display. The analog display depicts or represents an analog clock or an analog timer in accordance with different ones of said DVR recording modes.

The time control signals can comprise first control signals enabling indication of time of day by said clock and second control signals enabling indication of elapsed time and time remaining by said clock.

It will be appreciated by those skilled in the art that the typical operating menus used for controlling a typical set top box are generally well known and understood, but are nevertheless needed to explain and to provide a context for the inventive arrangements taught herein. Accordingly, various operating menus will be shown in the drawings but will not be described in detail.

FIG. 1 illustrates a set top box 10 having a front panel 12. The front panel 12 has a first set 14 of activatable control buttons, a ring clock 16 surrounding a Select rocker control button 18, a second set of activatable control buttons 20, and a set 22 of illuminated indicators. Apart from the ring clock 16, which in prior art set top boxes is merely an illuminated decorative ring, the set top box and the control buttons and indicators as illustrated are typical. The control buttons and indicators duplicate functionality and information that can be displayed on a video device connected to the set top box, in response to operation of a remote control device, not shown. Such remote control devices typically include, inter alia, a multidirectional pushbutton-rocker switch or a plurality of separate switches that provide functionality comparable to the Select button 18.

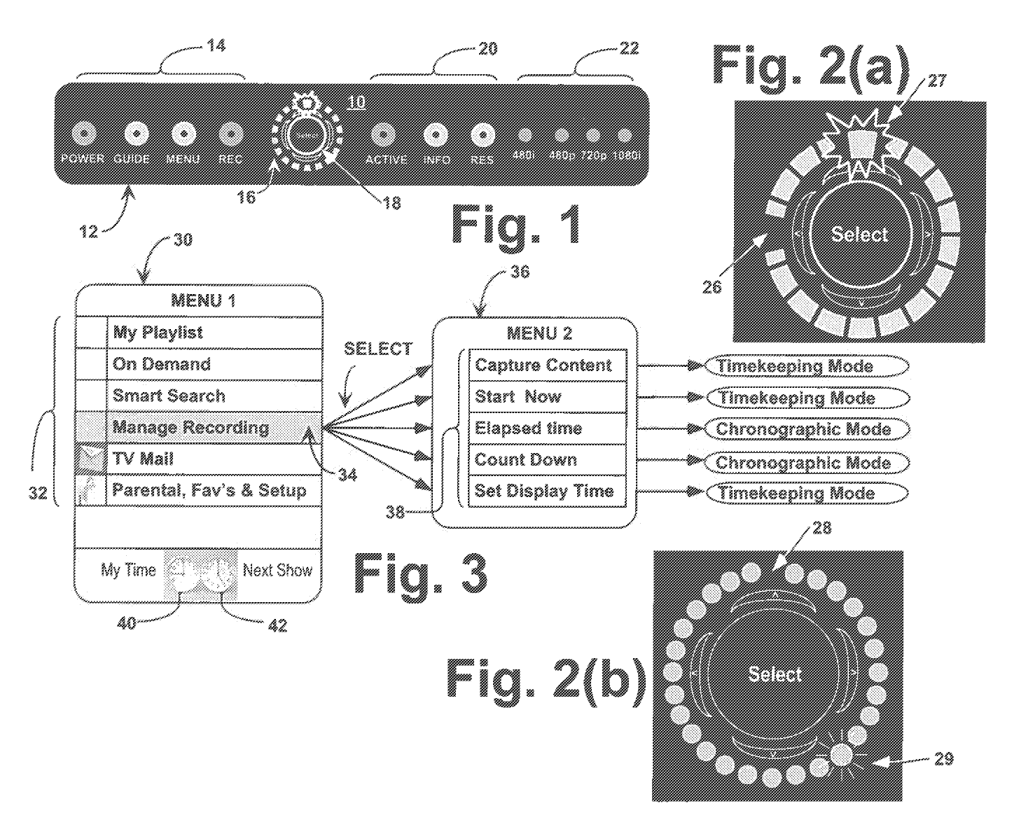

A first enlarged view of an embodiment of the ring clock 16 in a timekeeping mode is shown in FIG. 2(a), wherein the illuminable segments of the ring clock are rounded, rectangular-like shapes. The non-illuminated segment 26 can be interpreted as an hour hand on a regular clock. The blinking segment 27, depicted by a star-like border, can be interpreted as a minute hand. The time thus displayed and interpreted is 9:00. A second enlarged view of another embodiment of the ring clock 16 is shown in a timekeeping mode in FIG. 2(b). The illuminable segments of the ring are round, and there are more segments in the ring clock of FIG. 2 than FIG. 3. As in FIG. 2(a), the non-illuminated segment 28 can be interpreted as an hour hand on a regular clock. The blinking segment 29, depicted by white radiating lines, can be interpreted as a minute hand. The combination of the non-illuminated segment and the blinking segment shown in FIG. 2(b) can thus be interpreted, for example, as 12:20. Alternatively, for example, 12:20 can be illustrated by interchanging the blinking and non-illuminated segments. In a presently preferred embodiment, the blinking segments blink at a rate of about four times per second, but other rates can be implemented.

As can be seen, the time functions displayed by the segmented ring clock are not intended to have the precision of a regular clock or watch, but are intended for general indications of time or DVR operation. The precision of the ring clock 16 can be increased by increasing the number of illuminable segments, and in this regard, the number of illustrated segments comprising the ring clock shown in the drawings is merely illustrative. In a presently preferred embodiment, the illuminable segments correspond to light emitting diodes (LED's). It will be appreciated that the area available for the clock ring on the front panel and the diameter of the LED's used for the ring clock will define the maximum precision. The illuminable segments, for example LED's as noted above, need not be an array of discrete elements, but in accordance with another presently preferred embodiment, the illuminable segments can be a unitary semiconductor-based array or mechanical assembly. In this regard, the illustrations of the ring clock in the drawings represent both discrete and integrated implementations. It should be appreciated that high precision is not required to implement and utilize the inventive features, but higher precision can be provided, for example, to satisfy customer demand.

FIG. 3 illustrates a typical main menu generated by the set top box. A first menu 30, denoted Menu 1, provides a set 32 of selectable options. Clocks 40 and 42 are not visible on the front panel of the set top box, but are only visible in a formatted display that blocks some or all of the picture content on the television or monitor display. Clock 40 is denoted My Time and corresponds generally to the time shown on ring clock 16 in FIG. 2(a). Clock 42 is denoted Next Show.

The selection of the Manage Recording option 34 provides a second menu 36, denoted Menu 2. Menu 2 provides a set 38 of selectable options related to different DVR functions. The ring clock 16 will have different modes of operation and appearance according to which one of the Menu 2 options is selected. When Capture Content or Start Now is selected the ring clock 16 operates in the timekeeping mode. Accordingly, the menus invoked by these selections are not shown or explained in detail, as the timekeeping mode of the ring clock has already been shown and explained.

Briefly, the selection of Capture Content invokes a control interface for manually or automatically recording programs. The selection of Start Now invokes a control interface for identifying available programs for viewing or recording.

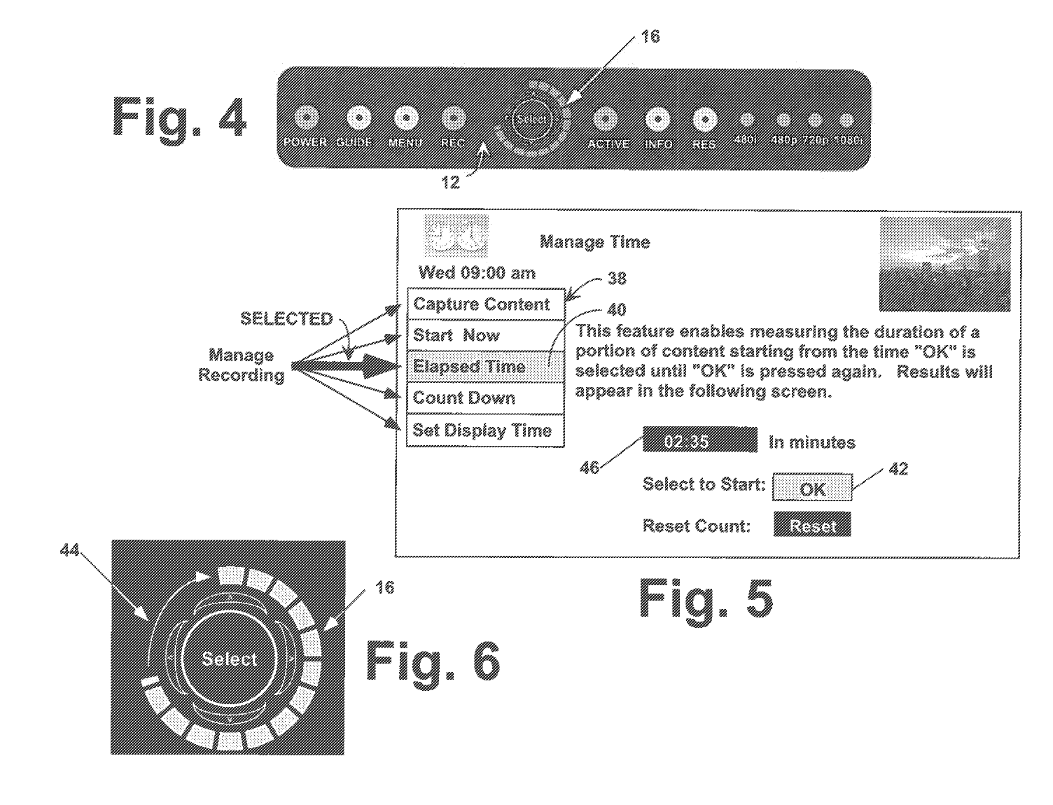

With reference to FIG. 5, the selection of the Elapsed Time feature 40 in Menu 2 (36) results in ring clock 16 operating in the chronograph or timer mode. The Elapsed Time feature measures the duration of a portion of content starting from the time the OK button 42 is selected until the OK button is pressed again. The chronographic display reminds a viewer that the elapsed time is still running. When the OK button is next activated the chronographic mode ends and the viewer can access the amount of elapsed time in window 46. With reference to FIGS. 4 and 6, the condition of elapsing time is shown on the ring clock 16. In the enlarged view of FIG. 6, the running time is indicated by successive illumination of each of the illuminable segments in order, around the ring. When all of the segments have been illuminated, all of the segments are turned off, and the successive illumination of segments around the ring begins again. The sequence continues until the time duration has fully elapsed. FIG. 6 illustrates a moment in time when about three-quarters of the segments have been illuminated and one-fourth (44) are turned off. In a presently preferred embodiment, each segment is turned on about one-fourth of a second after the preceding segment has been turned on.

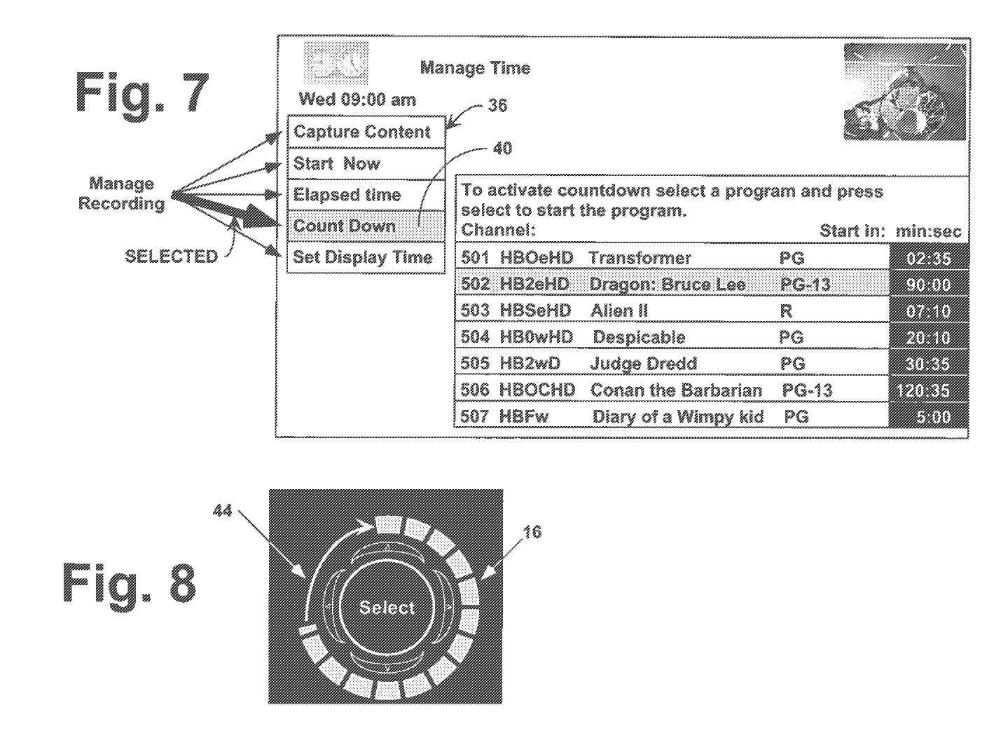

With reference to FIGS. 7-8, the selection of the Count Down feature 40 in Menu 2 (36) also results in ring clock 16 operating in the chronograph or timer mode. The Count Down feature enables a user to select a program that will begin at some later time of day. The chronographic feature enables the user to see that the later time of day has been reached when the chronographic operation stops.

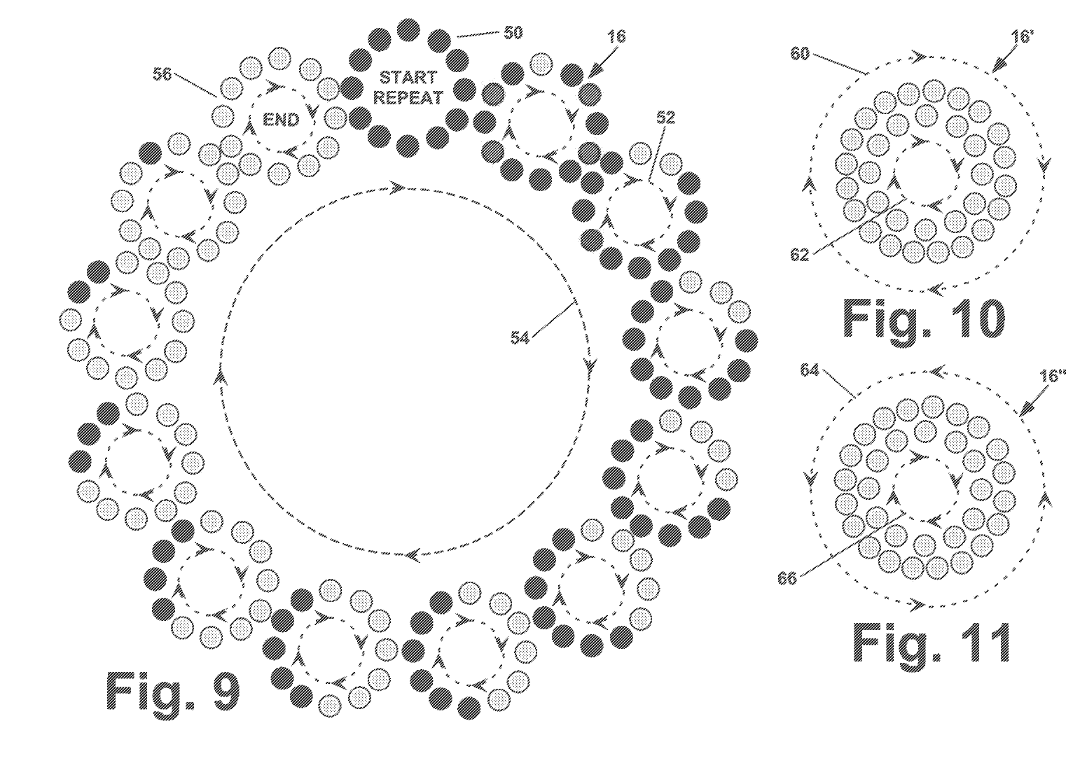

A thirteen picture sequence of how the ring clock appears in a complete chronographic sequence is shown more fully in FIG. 9. The sequence begins at the Start-Repeat position 50 where none of the illuminable segments is illuminated, that is, all segments are dark. At quarter-second intervals, for example as explained above, another illuminable segment is illuminated in a clockwise direction indicated by arrows 52 inside of each ring clock 16; the entire sequence being indicated by arrows 54. The sequence ends at position 56 when all segments are illuminated, after which the sequence repeats until the Elapsed Time or the Count Down Time has expired. The sequence can be implemented in a counter-clockwise direction, although this is not presently preferred. An aspect of the inventive arrangements lies in the simplicity of the smart display of DVR features utilizing a segmented ring clock as described herein. However, ring clocks with multiple rings of illuminable segments, and ring clocks with illuminable patterns other than those described herein in detail for one or more rings of illuminable segments related to DVR operation in the set top box, can also be provided in accordance with the inventive arrangements.

FIG. 10 illustrates a first alternative ring clock 16′ having multiple rings 60 and 62 in which both rings implement patterns of segment illumination in the same direction, for example clockwise. The multiple rings 60 and 62 can also implement patterns of segment illuminable in the counter clockwise.

FIG. 11 illustrates a second alternative ring clock 16″ having multiple rings 64 and 66 in which the rings implement patterns of segment illumination in opposite directions. The outer ring 64 is shown as implementing a counterclockwise pattern of segment whereas the inner ring 66 is shown as implementing a clockwise pattern of segment illumination. The rotational directions of the outer and inner rings 64 and 66 can be reversed relative to one another.

Briefly, the selection of the Set Display Time feature enables viewers to choose times of day at which selected programs will begin, or to choose time durations by which selected programs will be time shifted for later display. The ring clock 16 operates in the timekeeping mode when the Set Display Time feature is used.

The manner for generating time signals in a set top box is well understood, is not in and of itself an aspect of the inventive arrangements, and need not be described herein in detail. Similarly, the generation of DVR control signals in a set top box is also well understood, is not in and of itself an aspect of the inventive arrangements, and need not be described herein in detail.

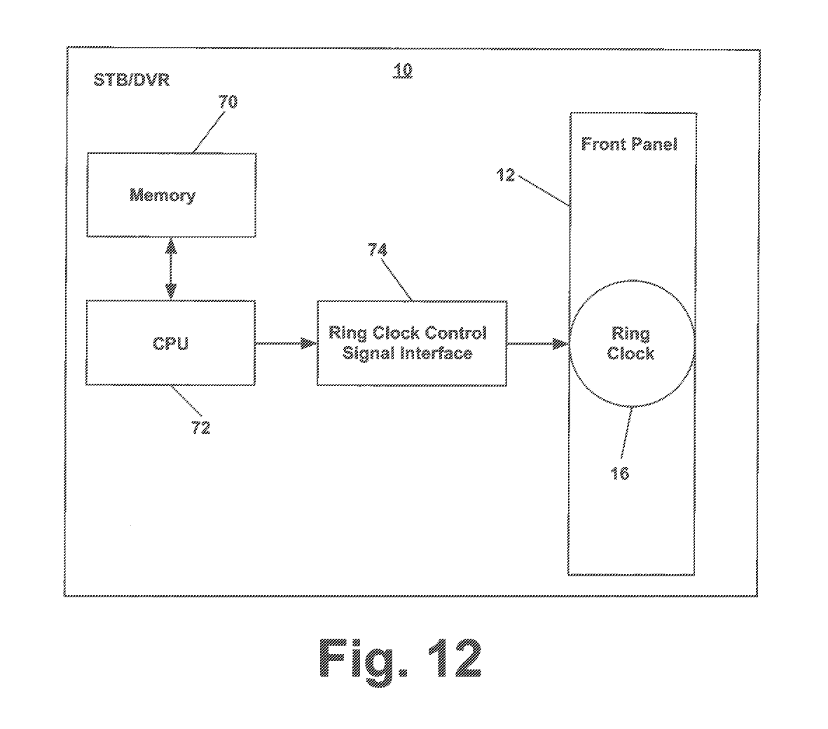

FIG. 12 is a high level block diagram showing how control signals are routed to the ring clock 16. The set top box 10 has the front panel 12 and the ring clock 16 on the front panel. A central processing unit (CPU) 72 and a memory 70 share data during operation of the set top box responsive to control signals from a typical remote control unit (not shown) responsive to user/viewer selections. Based on those selections, as described above in detail, selection of the Capture Content menu, the Start Now menu or the Set display Time menu will result in the CPU 72 sending control signals to the ring clock 16 through the Ring Clock Control Signal Interface 74 to operate in the timekeeping mode. As also described in detail above, selection of the Elapsed Time menu or the Count Down menu will result in the CPU 72 sending control signals to the ring clock 16 through the Ring Clock Control Signal Interface 74 to operate in the chronograph mode. The control signals for the ring clock will be more or less complex depending upon whether the ring clock has one ring of illuminable segments or multiple rings of illuminable segments. In this regard, it is within the contemplated scope of the inventive arrangements that the foregoing description of ring clocks having one or multiple rings of illuminable segments and having at least two operating modes can encompass ring clocks having further rings of illuminable segments and further operating modes.

The inventive features are not limited to the precise arrangements and instrumentalities shown. Reference should be made to the appended claims rather than to the specification to determine the scope of the inventive arrangements.

1. A set top box, comprising:
a digital video recorder (DVR);
first circuitry for processing and generating time control signals for said DVR;
second circuitry for generating a user interface enabling implementation of DVR recording modes, said DVR recording modes requiring different ones of said time control signals; and,
a front panel having a multi-mode ring-shaped clock formed by a plurality of independently illuminable segments operable in response to said time control signals generated for said DVR and in accordance with said DVR recording modes.

2. The set top box of claim 1, wherein said illuminable segments provide a visually perceivable analog display.

3. The set top box of claim 2, wherein said analog display is an analog clock or an analog timer in accordance with different ones of said DVR recording modes.

4. The set top box of claim 1, wherein said illuminable segments are formed by at least one of: light emitting diodes, organic light emitting diodes, quantum dots and liquid crystals.

5. The set top box of claim 1, wherein said illuminable segments can be illuminated to depict times for starting and stopping recordings, measuring elapsed times and remaining times for recordings, and times for playing back recordings.

6. The set top box of claim 1, wherein said time control signals comprise:
first control signals enabling indication of time-of-day by said clock; and,
second control signals enabling indication of elapsed time and time remaining by said clock.

7. The set top box of claim 1, wherein:
said illuminable segments can be illuminated to depict times for starting and stopping recordings, measuring elapsed times and remaining times for recordings, and times for playing back recordings; and,
said time control signals comprise: first control signals enabling indication of time-of-day by said clock; and, second control signals enabling indication of elapsed time and time remaining by said clock.

8. The set top box of claim 1, wherein:
said illuminable segments provide a visually perceivable display of an analog clock or an analog timer in accordance with different ones of said DVR recording modes;
said illuminable segments can be illuminated to depict times for starting and stopping recordings, measuring elapsed times and remaining times for recordings, and times for playing back recordings; and,
said time control signals comprise: first control signals enabling indication of time-of-day by said clock; and, second control signals enabling indication of elapsed time and time remaining by said clock.

9. The set top box of claim 1, wherein said illuminable segments are formed by light emitting diodes.

10. An improved set top box, comprising:
a digital video recorder (DVR);
first circuitry for processing and generating time control signals for said DVR;
second circuitry for generating a user interface enabling implementation of DVR recording modes, said DVR recording modes requiring different ones of said time control signals; and,
a front panel;
said improvement comprising:
a multi-mode ring-shaped clock on said front panel, formed by a plurality of independently illuminable segments operable in response to said time control signals generated for said DVR, and in accordance with said DVR recording modes.

11. The improved set top box of claim 10, wherein said illuminable segments provide a visually perceivable analog display.

12. The improved set top box of claim 11, wherein said analog display is an analog clock or an analog timer in accordance with different ones of said DVR recording modes.

13. The improved set top box of claim 10, wherein said illuminable segments are formed by at least one of: light emitting diodes, organic light emitting diodes, quantum dots and liquid crystals.

14. The improved set top box of claim 10, wherein said illuminable segments can be illuminated to depict times for starting and stopping recordings, measuring elapsed times and remaining times for recordings, and times for playing back recordings.

15. The improved set top box of claim 10, wherein said time control signals comprise: first control signals enabling indication of time-of-day by said clock; and, second control signals enabling indication of elapsed time and time remaining by said clock.

16. The improved set top box of claim 10, wherein:
said illuminable segments can be illuminated to depict times for starting and stopping recordings, measuring elapsed times and remaining times for recordings, and times for playing back recordings; and,
said time control signals comprise: first control signals enabling indication of time-of-day by said clock; and, second control signals enabling indication of elapsed time and time remaining by said clock.

17. The improved set top box of claim 10, wherein:
said illuminable segments provide a visually perceivable display of an analog clock or an analog timer in accordance with different ones of said DVR recording modes;
said illuminable segments can be illuminated to depict times for starting and stopping recordings, measuring elapsed times and remaining times for recordings, and times for playing back recordings; and,
said time control signals comprise: first control signals enabling indication of time-of-day by said clock; and, second control signals enabling indication of elapsed time and time remaining by said clock.
